(19) United States
(12) Patent Application Publication
(10) Pub. No.: US 2009/0032765 A1
(43) Pub. Date: Feb. 5, 2009

(54) Selective barrier polishing slurry

(76) Inventors: Jinru Bian, Newark, DE (US); Qianqiu Ye, Newark, DE (US)

Correspondence Address: ROHM AND HAAS ELECTRONIC MATERIALS;CMP HOLDINGS, INC., 451 BELLEVUE ROAD, NEWARK, DE, 19713, US

(21) Appl. No.: 11/890,108

(22) Filed: Aug. 3, 2007

(51) Int. Cl. C09K 13/00

(52) U.S. Cl. 252/79.1

(57) ABSTRACT

The aqueous slurry is useful for chemical mechanical polishing a semiconductor substrate having copper interconnects. The slurry contains by weight percent, 0 to 25 oxidizing agent, 0.1 to 30 abrasive particles, 0.001 to 5 benzenecarboxylic acid, 0.00002 to 5 multi-component surfactant, the multi-component surfactant having a hydrophobic tail, a nonionic hydrophilic portion and an anionic hydrophilic portion, the hydrophobic tail having 6 to 30 carbon atoms and the nonionic hydrophilic portion having 10 to 300 carbon atoms, 0.001 to 10 inhibitor for decreasing static etch of the copper interconnects, 0 to 5 phosphorus-containing compound for increasing removal rate of the copper interconnects, 0 to 10 complexing agent formed during polishing and balance water.

### BACKGROUND OF THE INVENTION

As ultra-large-scale-integrated circuit (ULSI) technology migrates to smaller lines widths, there are new challenges for the integration of conventional chemical mechanical polishing (CMP) processes. In addition, the introduction of low-k and ultra-low k dielectric films requires the use of a gentler CMP processes due to the films' low mechanical strength and weak adhesion to adjacent layers. Furthermore, ever-tightening defectivity specifications have placed additional demands on polishing slurries for low k films.

The integration of various low k films into USLIs can also require numerous extra steps and the incorporation of new technologies such as supercritical cleaning, dielectric and metal caps, conformal deposition of barriers and copper, chemical mechanical planarization with low down force and abrasive-free slurries. In addition to these technical options, ULSI fabricators must consider and address process complexity versus yield, reliability, mechanical strength, and performance, namely power dissipation from resistance-capacitance (RC) delay.

The complexities surrounding implementation of low k materials have introduced larger challenges for the barrier CMP process, which will necessitate the ability to control the complicated input variables and achieve a consistent high yield. Tuning process variables can contribute to decreasing polishing variation on the low k film. But the most desirable barrier CMP slurry will incorporate a low k dielectric-specific, surface activated agent that has process tunable performance adjustability. For example, Bian in US Pat. Pub. No. 2006/0131275, discloses a slurry that includes a surfactant having a hydrophobic tail, a non-ionic hydrophilic portion and an anionic hydrophilic portion for decreasing low-k removal rates, such as carbon-doped oxide (CDO).

There is a demand for a polishing slurry that can achieve the modular removal of barriers to ultra low k dielectrics with decreased CDO removal rates. Furthermore, there is a demand for a slurry that can remove a barrier with a high selectivity of barrier to dielectric removal rate.

### STATEMENT OF THE INVENTION

In one aspect of the invention, the invention includes an aqueous slurry useful for chemical mechanical polishing a semiconductor substrate having copper interconnects comprising by weight percent, 0 to 25 oxidizing agent, 0.1 to 30 abrasive particles, 0.001 to 5 benzenecarboxylic acid, 0.00002 to 5 multi-component surfactant, the multi-component surfactant having a hydrophobic tail, a nonionic hydrophilic portion and an anionic hydrophilic portion, the hydrophobic tail having 6 to 30 carbon atoms and the nonionic hydrophilic portion having 10 to 300 carbon atoms, 0.001 to 10 inhibitor for decreasing static etch of the copper interconnects, 0 to 5 phosphorus-containing compound for increasing removal rate of the copper interconnects, 0 to 10 complexing agent formed during polishing and balance water.

In another aspect of the invention, the invention includes an aqueous slurry useful for chemical mechanical polishing a semiconductor substrate having copper interconnects comprising by weight percent, 0.01 to 15 oxidizing agent, 0.1 to 40 silica abrasive particles, 0.01 to 3 benzenecarboxylic acid, 0.00005 to 2 multi-component surfactant, the multi-component surfactant having a hydrophobic tail, a nonionic hydrophilic portion and an anionic hydrophilic portion, the hydrophobic tail having 8 to 20 carbon atoms and the nonionic hydrophilic portion having 20 to 200 carbon atoms; 0.002 to 5 azole inhibitor for decreasing static etch of the copper interconnects, 0 to 3 phosphorus-containing compound for increasing removal rate of the copper interconnects, 0.01 to 5 organic acid complexing agent formed during polishing and balance water; and the aqueous slurry having a pH of 6 to 12.

In another aspect of the invention, the invention includes an aqueous slurry useful for chemical mechanical polishing a semiconductor substrate having copper interconnects comprising by weight percent, 0.1 to 10 oxidizing agent, 0.25 to 35 silica abrasive particles, 0.02 to 2.5 benzenecarboxylic acid, 0.0001 to 1 multi-component surfactant, the multi-component surfactant having a hydrophobic tail, a nonionic hydrophilic portion and an anionic hydrophilic portion, the hydrophobic tail having 12 to 16 carbon atoms and the nonionic hydrophilic portion having 25 to 150 carbon atoms; 0.005 to 2 benzotriazole inhibitor for decreasing static etch of the copper interconnects, 0.001 to 2 phosphorus-containing compound for increasing removal rate of the copper interconnects, 0.01 to 5 organic acid complexing agent formed during polishing and balance water; and the aqueous slurry having a pH of 7 to 11.5.

### DETAILED DESCRIPTION

It has been discovered that a combination of benzenecarboxylic acids and multi-components surfactants can increase tantalum nitride removal rate without an adverse impact upon the low k and ultra low k removal rates of semiconductor substrates. For purposes of this specification, semiconductor substrates include wafers having metal conductor interconnects and dielectric materials separated by insulator layers in a manner that can produce specific electrical signals. Furthermore, these slurries unexpectedly improve the wafer's defectivity. Finally, these slurries provide a stable film after the CMP process that facilitates excellent barrier to low k removal rate selectivity.

The slurry contains 0.001 to 5 weight percent benzenecarboxylic acid for accelerating barrier removal rates, such as TaN removal rate. Preferably, the slurry contains 0.01 to 3 weight percent benzenecarboxylic acid. Most preferably, the slurry contains 0.02 to 2.5 benzenecarboxylic acid. Example benzenecarboxylic acids include at least one of the following: terephthalic acid, benzene-1,3-dicarboxylic acid, benzene-1,2,4-tricarboxylic acid, benzene-1,3,5-tricarboxylic acid, benzene-1,2,3-tricarboxylic acid, benzene-1,2,3,4-tetracarboxylic acid, benzene-1,2,4,5-tetracarboxylic acid, benzene-1,2,3,5-tetracarboxylic acid and benzene-1,2,3,4,5-pentancarboxylic acid. Benzenecarboxylic acids having at least two carboxylic groups per benzene ring provide the greatestest increase in tantalum nitride removal rate. For example, the slurry may contain a benzenecarboxylic acid selected from at least one of benzene-1,3-dicarboxylic acid, benzene-1,2,4-tricarboxylic acid, benzene-1,3,5-tricarboxylic acid, benzene-1,2,3-tricarboxylic acid, benzene-1,2,3,4-tetracarboxylic acid, benzene-1,2,4,5-tetracarboxylic acid, benzene-1,2,3,5-tetracarboxylic acid and benzene-1,2,3,4,5-pentancarboxylic acid. Preferably, the benzenecarboxylic acids have two to four carboxy groups per benzene ring. Four example, benzene-1,2,4-tricarboxylic acid with three carboxy groups per benzene ring provides an excellent increase in TaN removal rate.

A surface active agent or surfactant, as used in this specification refers to a substance that, when present, has the property of adsorbing onto the wafer substrate's surface or interfaces or alters the surface free energy of the wafer substrate's surface or interfaces. The term “interface” is a boundary between any two immiscible phases. The term “surface” denotes an interface where one phase is gas, usually air. Surfactants usually act to reduce interfacial free energy. Certain surfactants, such as fatty alcohol polyglycol ether sulfate, can suppress CDO rate, but these surfactants can increase wafer defect counts.

It has been discovered that benzene carboxylic acids in combination with multi-component surfactants can decrease CDO removal rates without an unacceptable increase in wafers' defectivity. The multi-component surfactants have a molecular structure of a first structural portion that has very little attraction for water known as a hydrophobic tail, a second structural portion that is a nonionic hydrophilic portion having an attraction for water and an anionic hydrophilic group that has a strong attraction for water—the anionic hydrophilic group has a negative ionic charge when it is ionized in a solution.

The hydrophobic groups usually are long chain hydrocarbons, fluorocarbons or siloxane chains that have a length suitable for aqueous solubility. In particular, the hydrophobic groups have a total number of 6 to 30 carbon atoms. Preferably, the hydrophobic group has 8 to 20 carbon atoms and most preferably, it has 12 to 16 carbon atoms. The hydrophobic portion can be either a straight chain, a branched chain or cyclic chain. The hydrophobic portion may be a saturated chain, unsaturated chain or contain an aromatic group. A particular example is straight chain polymers derived from fatty alcohols.

The nonionic hydrophilic portion contains 10 to 300 carbon atoms. Preferably, the nonionic hydrophilic portion contains 20 to 200 carbon atoms. Most preferably, the nonionic hydrophilic portion contains 25 to 150 carbon atoms. The nonionic hydrophilic portion can be either a straight chain, a branched chain or cyclic chain. The nonionic hydrophilic portion may be a saturated chain, unsaturated chain or contain an aromatic group. A particular example of a suitable nonionic hydrophilic portion is a straight chain of polyethylene oxide.

Example anionic portions include anionic portion contains at least one of carboxylic acid, sulfonic acid, sulfuric acid phosphonic acid and salts thereof or mixtures thereof. The preferred anionic portion contain a chemical group selected from at least one of carboxylate (carboxylic acid salt), sulfonate (sulfonic acid salt), sulfate (sulfuric acid salt), or phosphate (phosphoric and polyphosphoric acid ester). The hydrophilic part of the surfactant may contain one or more nitrogen atoms or one or more oxygen atoms or mixture thereof, but it preferably contains at least one of the ionizable groups to provide solubility and repulsive force to negatively charged surfaces, such as silica surfaces.

Typically, high selectivity can be achieved by addition of 0.00002 to 5 wt % of the multi-component surfactant. This specification refers to all concentrations in weight percent, unless specifically referenced otherwise. Furthermore, the disclosed ranges include combining and partially combining ranges and limits within ranges. Preferably, the surfactant is 0.00005 to 2 wt %; and most preferably, the surfactant is 0.0001 to 1 wt %.

Typically, these surfactants are added as ammonium, potassium, quantanary ammonium or sodium salts. Most preferably, the surfactant is added as an ammonium salt for high-purity formulations.

The multi-component surfactant preferably suppresses removal rate of carbon-doped oxide (CDO) (as measured in angstroms per minute) in a greater differential rate than it suppresses removal rate of a barrier film, such as tantalum (Ta) or tantalum nitride (TaN). If we define the relative suppression (ΔX) of removal rate of a film X as ΔX=(Xo−X)/Xo, where Xo and X stand for the removal rates of X film, measured in angstroms per minute, before and after addition of the surfactant, the surfactants disclosed in this invention preferably satisfy at least one of the following equations (using TaN as an example): Δ(CDO)>Δ(TaN), as measured with a microporous polyurethane polishing pad pressure measured normal to a wafer of 13.8 kPa (2 psi) and the conditions of the Examples. For example, when polishing at a pressure of 13.8 kPa and the conditions of the Examples with a Hi embossed Politex™ porous-coagulated polyurethane (Politex is a trademark of Rohm and Haas Company or its affiliates) with a surfactant-free composition provides a control polishing rate (Xo) of 500 angstroms per minute for carbon-doped oxide and 500 angstroms per minute for tantalum nitride. Then adding the multi-component surfactant reduces the polishing rates under the same conditions to 300 angstroms per minute for carbon-doped oxide and the removal rate for TaN must be larger than 300 angstroms per minute in order to satisfy the above selectivity equation.

The slurry optionally contains 0 to 5 phosphorus-containing compound. For purposes of this specification, a “phosphorus-containing” compound is any compound containing a phosphorus atom. Preferably, the slurry contains 0 to 3 phosphorus-containing compound. Most preferably, the slurry contains 0.001 to 2 phosphorus-containing compound. For example, phosphorus-containing compounds include phosphates, pyrophosphates, polyphosphates, phosphonates, phosphine oxides, phosphine sulphides, phosphorinanes, phosphonates, phosphites and phosphinates including, their acids, salts, mixed acid salts, esters, partial esters, mixed esters, and mixtures thereof, such as, phosphoric acid. In particular, the polishing slurry may include specific phosphorus-containing compounds as follows: zinc phosphate, zinc pyrophosphate, zinc polyphosphate, zinc phosphonate, ammonium phosphate, ammonium pyrophosphate, ammonium polyphosphate, ammonium phosphonate, diammonium phosphate, diammonium pyrophosphate, diammonium polyphosphate, diammonium phosphonate, potassium phosphate, dipotassium phosphate, guanidine phosphate, guanidine pyrophosphate, guanidine polyphosphate, guanidine phosphonate, iron phosphate, iron pyrophosphate, iron polyphosphate, iron phosphonate, cerium phosphate, cerium pyrophosphate, cerium polyphosphate, cerium phosphonate, ethylene-diamine phosphate, piperazine phosphate, piperazine pyrophosphate, piperazine phosphonate, melamine phosphate, dimelamine phosphate, melamine pyrophosphate, melamine polyphosphate, melamine phosphonate, melam phosphate, melam pyrophosphate, melam polyphosphate, melam phosphonate, melem phosphate, melem pyrophosphate, melem polyphosphate, melem phosphonate, dicyanodiamide phosphate, urea phosphate, including, their acids, salts, mixed acid salts, esters, partial esters, mixed esters, and mixtures thereof.

The preferable phosphorus-containing compounds include ammonium phosphate and phosphoric acid. Excessive ammonium phosphate, however, can introduce excessive amounts of free ammonium into solution. And excessive free ammonium can attack the copper to produce a rough metal surface. Adding phosphoric acid reacts with free alkali metals in situ, such as potassium to form potassium phosphate salt and dipotassium phosphate salt that are particularly effective.

The potassium compound also provides the benefit of forming a protective film that protects copper in aggressive post-CMP cleaning solutions. For example, the post-CMP wafer's film has sufficient integrity to protect the wafer in pH 12 solutions having aggressive copper complexing agents such as, tetramethylammonium hydroxide, ethanolamine and ascorbic acid.

Optionally, oxidizing agent in an amount of 0 to 25 weight percent also facilitates removal of barrier layers, such as tantalum, tantalum nitride, titanium and titanium nitride. Preferably, the slurry contains 0.01 to 15 weight percent oxidizer. Most preferably, the slurry contains 0.1 to 10 weight percent oxidizer. Suitable oxidizers include, for example, hydrogen peroxide, monopersulfates, iodates, magnesium perphthalate, peracetic acid and other peracids, persulfates, bromates, periodates, nitrates, iron salts, cerium salts, manganese (Mn) (III), Mn (IV) and Mn (VI) salts, silver salts, copper salts, chromium salts, cobalt salts, halogens, hypochlorites, or combinations comprising at least one of the foregoing oxidizers. The preferred oxidizer is hydrogen peroxide. It is to be noted that the oxidizer is typically added to the polishing composition just prior to use and in these instances the oxidizer is contained in a separate package and mixed at the place of use. This is particularly useful for unstable oxidizers, such as, hydrogen peroxide.

Adjusting the amount of oxidizer, such as peroxide, can also control the metal interconnect removal rate. For example, increasing the peroxide concentration increases the copper removal rate. Excessive increases in oxidizer, however, provide an adverse impact upon polishing rate.

The barrier metal polishing composition includes an abrasive for “mechanical” removal of the barrier material. The abrasive is preferably a colloidal abrasive. Example abrasives include the following: inorganic oxide, metal boride, metal carbide, metal hydroxide, metal nitride, or a combination comprising at least one of the foregoing abrasives. Suitable inorganic oxides include, for example, silica (SiO₂), alumina (Al₂O₃), zirconia (ZrO₂), ceria (CeO₂), manganese oxide (MnO₂), and mixtures thereof. Alumina is available in many forms such as alpha-alumina, gamma-alumina, delta-alumina, and amorphous (non-crystalline) alumina. Other suitable examples of alumina are boehmite (AlO(OH)) particles and mixtures thereof. Modified forms of these inorganic oxides such as polymer-coated inorganic oxide particles may also be utilized if desired. Suitable metal carbides, boride and nitrides include, for example, silicon carbide, silicon nitride, silicon carbonitride (SiCN), boron carbide, tungsten carbide, zirconium carbide, aluminum boride, tantalum carbide, titanium carbide, and mixtures comprising at least one of the foregoing metal carbides, boride and nitrides. Diamond may also be utilized as an abrasive if desired. Alternative abrasives also include polymeric particles and coated polymeric particles. The preferred abrasive is silica.

The abrasive has a concentration in the aqueous phase of the polishing composition of 0.1 to 50 weight percent. For abrasive-free solutions, a fixed abrasive pad assists with the removal of the barrier layer. Preferably, the abrasive concentration is 0.1 to 40 weight percent. And most preferably, the abrasive concentration is 0.25 to 35 weight percent. Typically, increasing abrasive concentration increases the removal rate of dielectric materials; and it especially increases the removal rate of low-k dielectric materials, such as carbon-doped oxide. For example, if a semiconductor manufacturer desires an increased low-k dielectric removal rate, then increasing the abrasive content can increase the dielectric removal rate to the desired level.

The abrasive preferably has an average particle size of less than 250 nm for preventing excessive metal dishing and dielectric erosion. For purposes of this specification, particle size refers to the colloidal silica's average particle size. Most preferably, the silica has an average particle size of less than 100 nm to further reduce metal dishing and dielectric erosion. In particular, an average abrasive particle size less than 75 nm removes the barrier metal at an acceptable rate without excessive removal of the dielectric material. For example, the least dielectric erosion and metal dishing occur with a colloidal silica having an average particle size is 20 to 75 nm. Decreasing the size of the colloidal silica tends to improve the selectivity of the solution; but it also tends to decrease the barrier removal rate. In addition, the preferred colloidal silica may include additives, such as dispersants to improve the stability of the silica at acidic pH ranges. One such abrasive is colloidal silica that is available from AZ Electronic Materials France S.A.S., of Puteaux, France.

In addition to the inhibitor, 0 to 10 weight percent complexing agent optionally prevents precipitation of nonferrous metals. Most preferably, the slurry contains 0.01 to 5 weight percent complexing agent. Preferably, the complexing agent is an organic acid. Example complexing agents include the following: acetic acid, citric acid, ethyl acetoacetate, glycolic acid, lactic acid, malic acid, oxalic acid, saliclylic acid, sodium diethyl dithiocarbamate, succinic acid, tartaric acid, thioglycolic acid, glycine, alanine, aspartic acid, ethylene diamine, trimethyl diamine, malonic acid, gluteric acid, 3-hydroxybutyric acid, propionic acid, phthalic acid, isophthalic acid, 3-hydroxy salicylic acid, 3,5-dihydroxy salicylic acid, gallic acid, gluconic acid, pyrocatechol, pyrogallol, tannic acid, and salts thereof. Preferably, the complexing agent is selected from the group consisting of acetic acid, citric acid, ethyl acetoacetate, glycolic acid, lactic acid, malic acid, oxalic acid. Most preferably, the complexing agent is citric acid.

An addition of 0.001 to 10 total weight percent inhibitor decreases removal rate of copper interconnects and protects the copper from static etch. For purposes of this application, copper interconnect refers to interconnects formed with copper having incidental impurities or copper-base alloys. Adjusting the concentration of an inhibitor adjusts the copper interconnect removal rate by protecting the metal from static etch. Preferably the slurry contains 0.002 to 5 inhibitor. Most preferably, the solution contains 0.005 to 2 weight percent inhibitor. The inhibitor may consist of a mixture of inhibitors. Azole inhibitors are particularly effective for copper interconnects. Typical azole inhibitors include benzotriazole (BTA), mercaptobenzothiazole (MBT), tolytriazole and imidazole. BTA is a particularly effective inhibitor for copper interconnects and imidazole can increase copper removal rate.

The slurry also optionally contains 0 to 5 weight percent polyvinyl pyrrolidone for removal of barrier with selective removal rates of low-k dielectric films. This specification expresses all concentrations in weight percent, unless specifically noted otherwise. Optionally, the slurry contains 0.002 to 3 weight percent polyvinyl pyrrolidone. Optionally, the slurry contains 0.01 to 2 weight percent polyvinyl pyrrolidone. For applications demanding barrier removal with a modest low-k removal rate, the slurry preferably contains less than 0.4 weight percent polyvinyl pyrrolidone. For applications demanding barrier removal with a low low-k removal rate, the slurry preferably contains at least 0.4 weight percent polyvinyl pyrrolidone. This non-ionic polymer facilitates polishing low-k and ultra low k dielectric films (typically, hydrophobic) and hard mask capping layer films.

The polyvinyl pyrrolidone preferably has a weight average molecular weight of 1,000 to 1,000,000. For purposes of this specification, weight average molecular weight refers to molecular weight measured by gel permeation chromatography. The slurry more preferably has a molecular weight of 1,000 to 500,000 and most preferably a molecular weight of 2,500 to 50,000. For example, polyvinyl pyrrolidone having a molecular weight ranging from 7,000 to 25,000 has proven particularly effective.

The polishing composition will operate with acidic and basic pH levels with a balance water. Preferably, the pH is between 6 and 12 and most preferably between 7 and 11.5. In addition, the solution most preferably relies upon a balance of deionized water to limit incidental impurities. A source of hydroxy ions, such as ammonia, sodium hydroxide or potassium hydroxide adjusts the pH in the basic region. Most preferably, the source of hydroxy ions is potassium hydroxide.

Optionally, the slurry may contain leveling agents such as chlorides or in particular, ammonium chloride, buffers, dispersion agents and surfactants. For example, the slurry optionally contains 0.0001 to 0.1 weight percent ammonium chloride. Ammonium chloride provides an improvement in surface appearance and it can also facilitate copper removal by increasing the copper removal rate.

The polishing composition can also optionally include buffering agents such as various organic and inorganic bases or their salts with a pKa in the pH range of greater than 8 to 12. The polishing composition can further optionally include defoaming agents, such as non-ionic surfactants including esters, ethylene oxides, alcohols, ethoxylate, silicon compounds, fluorine compounds, ethers, glycosides and their derivatives, and the like. The defoaming agent can also be an amphoteric surfactant. The polishing composition may optionally contain biocides, such as Kordex™ MLX (9.5-9.9% methyl-4-isothiazolin-3-one, 89.1-89.5% water and ≦1.0% related reaction product) or Kathon™ ICP III containing active ingredients of 2-methyl-4-isothiazolin-3-one and 5-chloro-2-methyl-4-isothiazolin-3-one, each manufactured by Rohm and Haas Company, (Kathon and Kordex are trademarks of Rohm and Haas Company).

Preferably, the slurry polishes a semiconductor substrate by applying the slurry to a semiconductor substrate by placing 21 kPa or less downward force on a polishing pad. The downward force represents the force of the polishing pad against the semiconductor substrate. The polishing pad may have a circular shape, a belt shape or a web configuration. This low downward force is particularly useful for planarizing the semiconductor substrate to remove a barrier material from the semiconductor substrate. Most preferably, the polishing occurs with a downward force of less than 15 kPa.

### EXAMPLES

A series of benzene carboxylic acid slurries (Comparative Slurries A to J and Example Slurries 1 to 7) mixed with a balance of deionized water are shown below in Table 1.

TABLE 1

| | | Multi-Component | | | |
|---|---|---|---|---|---|
| | Additive | Surfactant | BTA | | Silica |
| Slurry | (wt %) | (wt %) | (wt %) | pH | (wt %) |
| A | 0 | | 0.10 | 10 | 10 |
| B | 0.2 | | 0.10 | 10 | 10 |
| | 1,2,4,5-benzenetetracarboxylic acid | | | | |
| C | 0.3 | | 0.10 | 10 | 10 |
| | 1,2,4,5-benzenetetracarboxylic acid | | | | |
| D | 0.4 | | 0.10 | 10 | 10 |
| | 1,2,4,5-benzenetetracarboxylic acid | | | | |
| E | 0.6 | | 0.10 | 10 | 10 |
| | 1,2,4,5-benzenetetracarboxylic acid | | | | |
| F | 0.2 | | 0.10 | 10 | 10 |
| | 1,2,4-benzenetricarboxylic acid | | | | |
| G | 0.2 | | 0.10 | 10 | 10 |
| | 1,2,3,4,5,6- | | | | |
| | cyclohexanehexacarboxylic acid | | | | |
| H | 0.2 | | 0.10 | 10 | 10 |
| | Polyacrylic acid (M.W.: 1800) | | | | |
| I | 0.2 | | 0.10 | 10 | 10 |
| | Polyacrylic acid (M.W.: 5000) | | | | |
| J | 0.2 | | 0.10 | 10 | 10 |
| | Polyacrylic acid (M.W.: 10000) | | | | |
| K | 0.2 | | 0.10 | 10 | 10 |
| | Benzolic acid | | | | |
| J | 0.2 | | 0.10 | 10 | 10 |
| | Terephthalic acid | | | | |
| 1 | 0.2 | 0.005 | 0.10 | 8 | 10 |
| | 1,2,4-benzenetricarboxylic acid | | | | |
| 2 | 0.2 | 0.007 | 0.10 | 8 | 10 |
| | 1,2,4-benzenetricarboxylic acid | | | | |
| 3 | 0.2 | 0.01 | 0.10 | 8 | 10 |
| | 1,2,4-benzenetricarboxylic acid | | | | |
| 4 | 0.2 | 0.015 | 0.10 | 8 | 10 |
| | 1,2,4-benzenetricarboxylic acid | | | | |
| 5 | 0.2 | 0.03 | 0.10 | 9 | 8* |
| | 1,2,4-benzenetricarboxylic acid | | | | |
| 6 | 0.4 | 0.03 | 0.10 | 9 | 8* |
| | 1,2,4-benzenetricarboxylic acid | | | | |
| 7 | 0.8 | 0.03 | 0.10 | 9 | 8* |
| | 1,2,4-benzenetricarboxylic acid | | | | |

Multi-Component Surfactant = Disponil ™ FES surfactant manufactured by Cognis Chemical Group,
NH₄Cl = 0.01 wt %,
BTA = benzotriazole,
Biocide = 0.005 wt % Kordex ™ MLX manufactured by Rohm and Haas Company (9.5-9.9% methyl-4-isothiazolin-3-one, 89.1-89.5% water and ≦1.0% related reaction product),
Silica = Klebasol II a 50 nm silica from AZ Electronic Materials France S.A.S., of Puteaux, France,
Silica* = 1501-50 a 50 nm silica from AZ Electronic Materials France S.A.S., of Puteaux, France and all slurries included 0.20 wt % H₂O₂.

### Example 1

Polishing tests employed 200 mm sheet wafers of Coral™ carbon-doped oxide (CDO) from Novellus Systems, Inc., TEOS dielectric, tantalum nitride, and electroplated copper. Topographical data arise from polishing sheet wafers with IC1010™ and embossed Politex™ polishing pads from Rohm and Haas Electronic Materials CMP Technologies.

A MIRRA™ rotary type polishing platform polished the sheet wafers. First step copper polishing used Eternal slurry EPL2360 with an IC1010™ circular grooved polyurethane polishing pad on platens 1 and 2 using a Kinik AD3CG-181060 grid diamond conditioning disk. The polishing conditions for platens 1 were platen speed 93 rpm, carrier speed 21 rpm and downforce of 4 psi (27.6 kPa) and platen 2 platen speed of 33 rpm, carrier speed 61 rpm and downforce of 3 psi (20.7 kPa). The polishing conditions for platen 3 were 1.5 psi (10.3 kPa) downforce, 93 rpm platen speed, 87 rpm carrier speed with a slurry flow rate of 200 ml/min. using Hi embossed Politex™ coagulated polyurethane polishing pads.

Removal rates were calculated from the before and after polish film thicknesses. All optically transparent films were measured using a Tencor SM300 ellipsometric measuring device configured at 170×10⁻⁶Ω for copper and 28,000×10⁻⁶Ω for tantalum nitride. Wafer topography data was collected using a Dektak Veeco V200SL stylus profilometer. All the reported removal rates are in units of Å/min.

Table 2 provides polishing screening results from the series of polishing additives.

TABLE 2

| | TaN | TEOS | CDO | Cu |
|---|---|---|---|---|
| Slurry | (Å/min.) | (Å/min.) | (Å/min.) | (Å/min.) |
| A | 354 | 292 | 447 | 399 |
| B | 610 | 447 | 689 | 248 |
| C | 840 | 539 | 869 | 164 |
| D | 864 | 584 | 999 | 211 |
| E | 915 | 612 | 1168 | 219 |
| F | 771 | 529 | 840 | 206 |
| G | 502 | 399 | 579 | 177 |
| H | 334 | 265 | 421 | 193 |
| I | 330 | 239 | 410 | 221 |
| J | 385 | 299 | 452 | 202 |
| K | 432 | 371 | 469 | 154 |
| L | 563 | 417 | 582 | 183 |
| 1 | 774 | 501 | 149 | 146 |
| 2 | 699 | 475 | 207 | 191 |
| 3 | 620 | 417 | 126 | 141 |
| 4 | 537 | 384 | 105 | 70 |

Table 2 illustrates that benzenecarboxylic acids increase TaN removal rate without an adverse increase in carbon-doped oxide removal rate. In particular, benzenemulti-carboxylic acids provided the largest increase in TaN removal rate. In addition, slurries containing a combination of multi-component surfactant and benzenecarboxylic acid provided excellent TaN removal rates in combination with low carbon-doped oxide removal rate.

TABLE 3

| | Multi- | 1,2,4- | | | | |
|---|---|---|---|---|---|---|
| | Component | benzenetricarboxylic | | | | |
| | Surfactant | acid | TEOS | Cu | TaN | CDO |
| Slurry | (wt %) | (wt %) | (Å/min.) | (Å/min.) | (Å/min.) | (Å/min.) |
| A | | | 292 | 399 | 354 | 447 |
| 5 | 0.03 | 0.2 | 315 | 92 | 358 | 68 |
| 6 | 0.03 | 0.4 | 441 | 90 | 668 | 73 |
| 7 | 0.03 | 0.8 | 428 | 103 | 685 | 91 |

Multi-Component Surfactant = Disponil ™ FES surfactant manufactured by Cognis Chemical Group.

Table 3 illustrates that benzene-1,2,4-tricarboxylic acid, having three carboxylic acids per ring, in combination with Disponel FES surfactant can provide high selectivity ratios for TaN removal rate to carbon-doped oxide removal rate. In addition, it demonstrates that the TaN removal rate benefit can diminish with increasing benzene-1,2,4-tricarboxylic acid to concentrations above 0.4 weight percent.

1. An aqueous slurry useful for chemical mechanical polishing a semiconductor substrate having copper interconnects comprising by weight percent. 0 to 25 oxidizing agent, 0.1 to 30 abrasive particles, 0.001 to 5 benzenecarboxylic acid, 0.00002 to 5 multi-component surfactant, the multi-component surfactant having a hydrophobic tail, a nonionic hydrophilic portion and an anionic hydrophilic portion, the hydrophobic tail having 6 to 30 carbon atoms and the nonionic hydrophilic portion having 10 to 300 carbon atoms, 0.001 to 10 inhibitor for decreasing static etch of the copper interconnects, 0 to 5 phosphorus-containing compound for increasing removal rate of the copper interconnects, 0 to 10 complexing agent formed during polishing and balance water.

2. The aqueous slurry of claim 1 wherein benzene rings of the benzene carboxylic acid contains at least two carboxyl groups.

3. The aqueous slurry of claim 1 wherein the slurry includes silica abrasive particles.

4. An aqueous slurry useful for chemical mechanical polishing a semiconductor substrate having copper interconnects comprising by weight percent, 0.01 to 15 oxidizing agent, 0.1 to 40 silica abrasive particles, 0.01 to 3 benzenecarboxylic acid, 0.00005 to 2 multi-component surfactant, the multi-component surfactant having a hydrophobic tail, a nonionic hydrophilic portion and an anionic hydrophilic portion, the hydrophobic tail having 8 to 20 carbon atoms and the nonionic hydrophilic portion having 20 to 200 carbon atoms; 0.002 to 5 azole inhibitor for decreasing static etch of the copper interconnects, 0 to 3 phosphorus-containing compound for increasing removal rate of the copper interconnects, 0.01 to 5 organic acid complexing agent formed during polishing and balance water; and the aqueous slurry having a pH of 6 to 12.

5. The aqueous slurry of claim 4 wherein benzene rings of the benzene carboxylic acid contains two to four carboxyl groups.

6. The aqueous slurry of claim 4 wherein the slurry includes silica abrasive particles having an average particle size of less than 100 nm.

7. The aqueous slurry of claim 4 wherein the benzenecarboxylic acid is selected from at least one of benzene-1,3-dicarboxylic acid, benzene-1,2-dicarboxylic acid, benzene-1,4-dicarboxylic acid, benzene-1,2,4-tricarboxylic acid, benzene-1,3,5-tricarboxylic acid, benzene-1,2,3-tricarboxylic acid, benzene-1,2,3,4-tetracarboxylic acid, benzene-1,2,4,5-tetracarboxylic acid, benzene-1,2,3,5-tetracarboxylic acid and benzene-1,2,3,4,5-pentancarboxylic acid.

8. An aqueous slurry useful for chemical mechanical polishing a semiconductor substrate having copper interconnects comprising by weight percent, 0.1 to 10 oxidizing agent, 0.25 to 35 silica abrasive particles, 0.02 to 2.5 benzenecarboxylic acid, 0.0001 to 1 multi-component surfactant, the multi-component surfactant having a hydrophobic tail, a nonionic hydrophilic portion and an anionic hydrophilic portion, the hydrophobic tail having 12 to 16 carbon atoms and the nonionic hydrophilic portion having 25 to 150 carbon atoms; 0.005 to 2 benzotriazole inhibitor for decreasing static etch of the copper interconnects, 0.001 to 2 phosphorus-containing compound for increasing removal rate of the copper interconnects, 0.01 to 5 organic acid complexing agent formed during polishing and balance water; and the aqueous slurry having a pH of 7 to 11.5.

9. The aqueous slurry of claim 8 wherein the benzenecarboxylic acid is selected from at least one of benzene-1,3-dicarboxylic acid, benzene-1,2-dicarboxylic acid, benzene-1,4-dicarboxylic acid, benzene-1,2,4-tricarboxylic acid, benzene-1,3,5-tricarboxylic acid, benzene-1,2,3-tricarboxylic acid, benzene-1,2,3,4-tetracarboxylic acid, benzene-1,2,4,5-tetracarboxylic acid, benzene-1,2,3,5-tetracarboxylic acid and benzene-1,2,3,4,5-pentancarboxylic acid.

10. The aqueous slurry of claim 8 wherein the benzenecarboxylic acid is benzene-1,2,4-tricarboxylic acid.
